(19) United States
(12) Patent Application Publication
(10) Pub. No.: US 2017/0098232 A1
(43) Pub. Date: Apr. 6, 2017

(54) Comprehensive Online Credit for Content (c4c) System

(71) Applicants: Charles S Pike, Missouri City, TX (US); Steven C. Throneberry, Austin, TX (US)

(72) Inventors: Charles S Pike, Missouri City, TX (US); Steven C. Throneberry, Austin, TX (US)

(21) Appl. No.: 14/874,362

(22) Filed: Oct. 2, 2015

(51) Int. Cl. G06Q 30/02

(52) U.S. Cl. CPC G06Q 30/0215; G06Q 30/0208

(57) ABSTRACT

An integrated, incentive-based online system for capturing and utilizing real-time, fresh, and contextual employee generated content™ (internal, feedback, best practices) in the form of customer interactions (testimonials, feedback, ideas, stories), employee interactions (stories, ideas, feedback), video, audio, graphics, images, etc. and providing credit to content authors (employees) for use in online stores and charitable donations. Companies manage their employee content through a dashboard and utilize submissions to connect and engage clients and potential clients.

Companies, small and large, are in constant need of high quality and timely content to utilize in sales, marketing, corporate websites, company blogs, LinkedIn, and social media (Facebook, Twitter, etc.) to highlight their services and to keep customers engaged and coming back. Currently, no system is available on the market to support organizations in capturing and rewarding employees for submission of internal content. The c4c System has broad application across all industries and content capture requirements.

### CROSS-REFERENCE TO RELATED APPLICATIONS

This patent claims the benefit of the prior-filed nonprovisional patent application on Oct. 2, 2015 with application Ser. No. 14/874,362 and confirmation no. 6137.

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

Organizations, small and large, are in constant need of high quality and timely content to utilize in sales, marketing, search engine optimization, corporate websites, company blogs, and social media (LinkedIn, Facebook, Twitter, Google+, etc.) to highlight their services and to keep customers engaged and coming back. Additionally, organizations have limited processes to identify and capture defined internal best practices and provide a continuous feedback loop. Currently, no system is available on the market to support organizations in capturing and rewarding employees for submission of content (internal, feedback, best practices) in the form of customer interactions (conversations, testimonials, feedback, ideas, stories), employee interactions (stories, ideas, feedback), video, audio, graphics, images, etc. The challenge in capturing content is the immediacy and real-time value of the content and the tacit experiences of employees. Job specific internal team members (marketing, operations) and/or outsourced third-party content providers have no way to address these challenges and fall short in providing relevant, real-time, and high value content.

There are systems currently available for managing content, but these systems do not encourage through an established rewards program to provide a mechanism for employees to submit real-time, fresh, contextual content and receive credit for their content submissions. Organizations utilize limited internal processes and/or pay third-party content providers to develop content for use in sales, marketing, and advertising. Content from these sources is often deficient in quality, timeliness, and relevancy, since the providers are not part of a company's culture. In addition, these external providers often develop content for multiple companies that are direct competitors to each other. The same content can be repurposed and becomes stale very quickly.

Organizations are lacking a comprehensive system for encouraging and rewarding employees for submitting real-time, fresh, contextual content as interactions occur every day. This invention captures employee content (internal, feedback, best practices) in a variety of formats (conversations, ideas, stories, video, images, graphics, etc.) as Reusable Content Objects (RCO's), lets them submit the content, and allows the company to review and utilize the content in a variety of applications and purposes. The RCO is given a credit value and employees use these credits to purchase items in a company store or donate their credits as dollar-value to selected charities.

### BRIEF SUMMARY OF THE INVENTION

An integrated, online system for incentivizing, capturing and utilizing real-time, fresh, and contextual employee generated content (EGC™) as internal content, feedback, and best practices in the form of customer interactions (testimonials, feedback, ideas, stories), employee interactions (stories, ideas, feedback), video, audio, graphics, images, etc. and providing credit to content authors (employees) for use in online stores and charitable donations.

The present invention is not currently available in the marketplace. Organizations may have a system for managing content using a content management system, a learning management system, or knowledge management system. However, these systems do not offer the ability for employees to develop and submit content for review and concomitant credit received for content submissions. The present invention provides the following unique advantages.
1. Incentive-based, integrated, online system to capture real-time, high value employee content (internal, feedback, best practices).
2. Secure cloud-based hosting.
3. Available behind corporate firewall with white label option.
4. API's available for integration into company knowledge and content management systems and automated marketing systems.
5. Employee submission of fresh content.
6. Company review and evaluation of content submissions.
7. Credit values assigned to content submissions.
8. Use of credit in company store and for charitable donations.
9. Reusable content for company websites, social media, sales, marketing, client services, etc.
10. 24/7 access for employees and company.
11. High quality end user experience with intuitive user interface.
12. Accessible from any PC/Mac and mobile device.

The present invention is built upon a MySQL and SQL backbone with SSL and TLS data transfer security. The UI (user interface) utilizes a standard browser protocol with structured navigation. The present invention is entirely online and can be accessed from PC/Mac computers/laptops and any mobile device.

### BRIEF DESCRIPTION OF THE SEVERAL VIEWS OF THE DRAWING

So that the invention can be understood in detail, associated drawings (FIG. 1 and FIG. 2) are provided. It is to be noted that the included drawings illustrate only typical examples of the description and are not to be considered limiting of its scope.

FIG. 1 illustrates an integrated, online system for incentivizing, capturing, managing, and utilizing real-time, internal content and providing credit to content authors for use in online stores and making charitable donations.

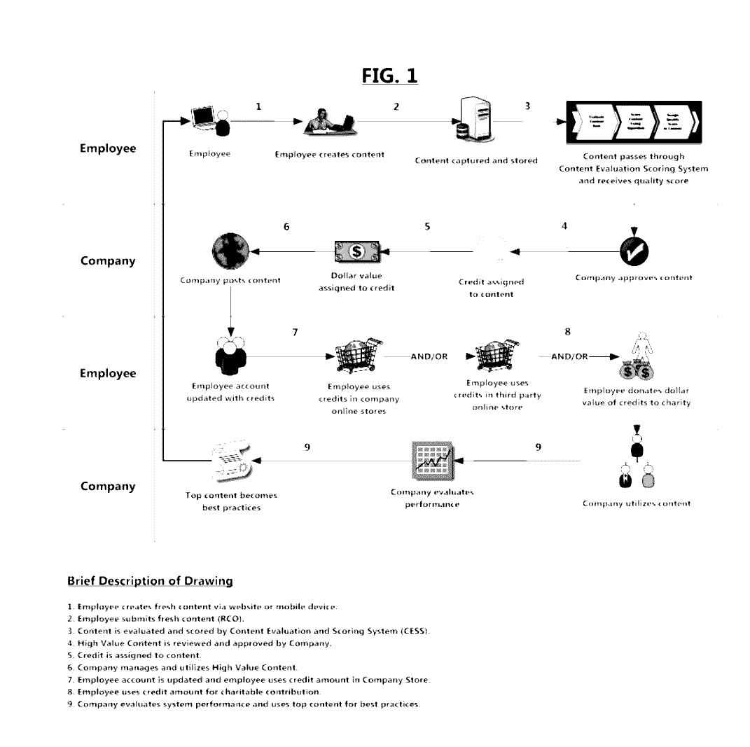

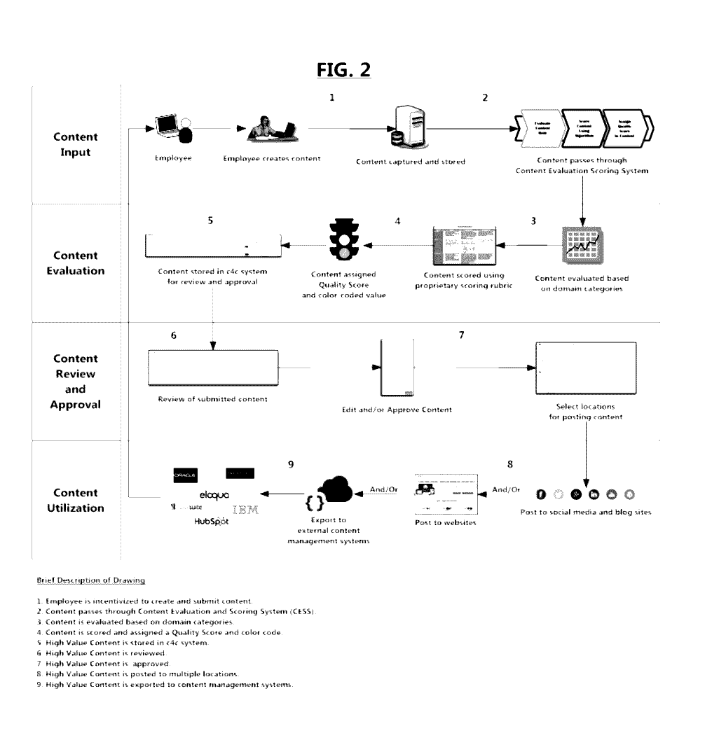

See FIG. 1 Drawing for more detail.
Step 1. Employees are incented and rewarded to create fresh, contextual content (Reusable Content Object (RCO)) via desktop icon or mobile access.
   a. Format can be customer interactions (testimonials, feedback, ideas, stories), employee interactions (stories, ideas, feedback), video, audio, graphics, images, etc. for company corporate sites and digital marketing.
   b. Employees capture tacit experiences for sharing.
   c. Company uses C4C Content Capture System© to capture and store in proprietary cloud database.
Step 2. Employee submits fresh content (RCO) for review and approval by Company.
Step 3. Content is evaluated and scored by Content Evaluation and Scoring System (CESS).
Step 4. High Value Content is reviewed and approved by Company.
Step 5. Employee account is updated with credit amount.
Step 6. Company manages and utilizes High Value Content (RCO) on company website, social media, marketing, advertising, etc.
Step 7. Employee account is updated with credit amount.
Step 8. Employee uses credit amount in Company Store (store has three options).
   a. Internal online store with merchandise
   b. Charitable donations
      i. Company identifies charities that employee can choose to apply credits toward.
      ii. Credits are converted to dollar value.
Step 9. Company evaluates system performance and uses top content for best practices.
   a. C4C Content Capture System© provides constant flow of real-time, internal content from employees, Subject Matter Experts (SME's), internal talent, etc. and reduces the need to use stand-alone programs or pay third-party content providers that may not understand the company culture, provide basic content not relevant to company needs, and charge for content.

FIG. 2 illustrates the Content Evaluation and Scoring System (CESS) for evaluating and scoring content submitted through the credit4content system.

See FIG. 2 Drawing for more detail.
Step 1. Employees are incented and rewarded to create and submit fresh, contextual content (Reusable Content Object (RCO)) via desktop icon or mobile access
   a. Format can be customer interactions (testimonials, feedback, ideas, stories, etc.), employee interactions (stories, ideas, feedback, etc.), video, audio, graphics, images, etc. for company corporate sites and digital marketing.
   b. Employees capture tacit experiences for sharing.
   c. Company uses C4C Content Capture System© to capture and store in proprietary cloud database
Step 2. Fresh content (RCO) passes through the Content Evaluation and Scoring System (CESS).
Step 3. Content is evaluated based on domain categories.
Step 4. Content is scored and assigned a Quality Score and color code.
Step 5. High Value Content is stored in c4c system.
Step 6. High Value Content is reviewed by company.
Step 7. High Value Content is approved by company.
Step 8. High Value Content is posted to multiple locations (websites, blogs, social media, etc.).
Step 9. High Value Content is exported to content management systems.

### DETAILED DESCRIPTION OF THE INVENTION

1. How would you describe your invention if you had only one phrase?
   An incentive-based integrated, online system for capturing and utilizing real-time, employee generated content (EGC™) as internal content, feedback, and best practices in the form of conversations, ideas, stories, video, audio, graphics, images, etc. and providing credit to content authors (employees) for use in online stores and charitable donations.
2. How would you describe your invention in broad general terms?
   The present invention provides a comprehensive incentive-based online system for capturing valuable and often overlooked employee generated content and then assigning credit value for each respective content submission. Individuals utilize their credit value within an online company store, third-party store, or for converting into charitable donations. The system offers companies a better way for capturing and utilizing higher quality content than content offered by limited internal resources and/or third-party content providers unfamiliar with company culture and specific needs.
3. What need does your invention fill?
   Currently, most organizations utilize non incentive-based and very limited internal processes or pay third-party content providers to develop content for use in sales, marketing, and advertising. Content from these sources is often deficient in quality, timeliness, and relevancy, since the providers are not part of a company's culture. In addition, these providers developing content externally can utilize the content for multiple companies that are direct competitors to each other. The same content just gets repurposed and becomes stale very quickly.
   Organizations are lacking a comprehensive system for providing employees a way to submit real-time, fresh, and contextual content (internal, feedback, best practices) and to reward employees for their contributions. This invention captures employee content in a variety of formats (conversations, ideas, stories, video, images, etc.) as Reusable Content Objects (RCO's), lets them submit the content, and allows the company to review and utilize the content in a variety of applications. The RCO is given a credit value and employees can then use these credits to purchase items in a company store or donate their credits as dollar-value to selected charities.
4. Concisely describe the most basic version of your invention, including key aspects, core components and technical/mechanical functionality of your invention. Only describe what is absolutely essential for your invention to work. The next question will focus on options and alternatives.
   This invention is built upon current technology standards and protocols and is delivered through a Software as a Service (SaaS) model. End users require only access to their company's approved user list (email account). Access is through any PC/Mac or mobile-enabled device. The backend is built upon standard database structure with all data transfers through Internet security protocols. The integrated system consists of the following interrelated components (incentivizing, content capture system, content evaluation and scoring system, credit value for content submitted and utilized, application of credit value in company store, and company utilization of content).
5. Describe the optional features of your invention.
   The present invention provides employees incentives and multiple pathways to submit real-time, fresh, and contextual content and receive credit for their submissions. It also offers employees several ways to utilize their credits. The system can be accessed behind a company's firewall and branded as their own system (white label).
6. Describe the most complete version of your invention.
   The present invention provides a comprehensive system for incentivizing content submissions, capturing employee content, and assigning credit for the quality and type of content submitted (internal, feedback, best practices). All interaction is online and data are transferred through standard Internet security protocols. The present invention is an integrated system containing the following components.
   1. Employee creates Reusable Content Object (RCO) via desktop icon or mobile device
      a. Format can be conversations, testimonials, images, video, audio, graphic, article, blog, tweet, and/or Facebook post for company corporate sites and digital marketing.
      b. Employees capture tacit experiences for sharing.
      c. Company uses C4C Content Capture System© to capture and store in proprietary cloud database
   2. Employee submits RCO for review and approval by Company
   3. Company reviews and approves content for use
   4. Credit values assigned to RCO types
   5. Employee account is updated with credit amount
   6. Employee uses credit amount in Company Store (store has three options)
      a. Internal online store with merchandise
      b. On-line stores (Amazon, etc.)
         i. Company selects merchandise where credits can be applied
      c. Charitable donations
         i. Company identifies charities that employee can choose to apply credits toward
         ii. Credits are converted to dollar value
   7. Company manages and utilizes RCO's on company website, social media, marketing, advertising, etc.
   8. C4C Content Capture System© provides constant flow of real-time, fresh and contextual content (internal, feedback, best practices) from employees, Subject Matter Experts (SME's), internal talent, etc. and reduces the need to pay third-party content providers that may not understand the company culture, provide basic content not relevant to company needs, and charge for content.
7. Explain what is deficient, missing, lacking, insufficient, undesirable and/or inferior about that which are similar, but albeit inferior, solutions.
   Currently, there are no employee facing credit-for-content systems available in the marketplace. There are systems available for managing content, but these systems do not provide incentives including recognition or automated processes for employees to submit real-time, fresh, and contextual content and receive credit for their content submissions.
   Most companies utilize limited internal processes and/or third-party content providers to develop content. Often, this content is lacking in relevancy, timeliness, and quality. This is due to providers not understanding or being part of the company culture. These third-party providers create the same content for multiple companies, so the content is recycled and not specific to company needs.
8. With an eye toward functionality and use, please describe what makes your invention different than other available solutions/inventions.
   The present invention is not currently available in the marketplace. Organizations may have a system for managing content using a learning management system or knowledge management system. However, these systems do not incentivize employees or offer the ability for employees to develop and submit content for review and concomitant credit received for content submissions. The present invention provides the following unique advantages.
   1. Integrated, online system to incentivize and capture real-time, high value employee generated content (Employee Generated Content′) in the form of internal content, feedback, and best practices.
   2. Secure cloud-based hosting.
   3. Available behind corporate firewall with white label option.
   4. API's available for integration into company knowledge and content management systems and automated marketing systems.
   5. Employee submission of real-time, fresh, and contextual content.
   6. Company review and evaluation of content submissions.
   7. Credit values assigned to content submissions.
   8. Use of credit in company store and for charitable donations.
   9. Reusable content for company websites, social media, sales, marketing, client services, etc.
   10. 24/7 access for employees and company.
   11. High quality end user experience with intuitive user interface.
   12. Accessible from any PC/Mac and mobile device.
9. With an eye toward structure, please describe what makes your invention different than other available solutions/inventions.
   Currently, there are no employee facing credit-for-content systems available in the marketplace that offer the functionality and features integrated into the present invention. The present invention is built upon a MySQL and SQL backbone with SSL and TLS data transfer security. The UI (user interface) utilizes a standard browser protocol with structured navigation. The present invention is entirely online and can be accessed from PC/Mac computers/laptops and any mobile device.
10. Is there anything else about your invention that you feel is important for us to know and which you have not yet stated in response to any of the preceding questions?
   The present invention would be the first content-for-credit system available in the marketplace.

1. The present invention comprises a comprehensive, incentive-based online system for capturing real-time, fresh, and contextual employee generated content™ (internal, feedback, best practices) and tacit experiences and then assigning credit value for each respective content submission. Employees submit content and receive credit for the pre-determined value of content types/categories. Credit is used by employees in a custom, online company store, third-party stores, and/or for charitable donations. Employees access a custom dashboard to track and manage content submission status and credit utilization. Using a custom dashboard, companies manage their employee content and utilize their submissions to connect and engage clients and potential clients.
